(19) United States
(12) Patent Application Publication
(10) Pub. No.: US 2013/0315132 A1
(43) Pub. Date: Nov. 28, 2013

(54) NETWORK CONNECTION DEVICE FOR SELECTIVELY CONNECTING TO WIRED NETWORK OR WIRELESS NETWORK AND SELECTIVELY PROVIDING DIFFERENT FUNCTIONS

(71) Applicants: Kuan-Yu Hou, New Taipei City (TW); Kuang-Yu Yen, Hsinchu County (TW); Yi-Shou Hsu, Hsinchu City (TW)

(72) Inventors: Kuan-Yu Hou, New Taipei City (TW); Kuang-Yu Yen, Hsinchu County (TW); Yi-Shou Hsu, Hsinchu City (TW)

(21) Appl. No.: 13/607,814

(22) Filed: Sep. 10, 2012

(30) Foreign Application Priority Data
May 23, 2012 (TW) 101118318

(51) Int. Cl. H04W 76/00; H04B 7/14; H04W 40/00

(52) U.S. Cl. 370/315; 370/328

(57) ABSTRACT

A network connection device includes a wired network module, for connecting an electronic apparatus to a wired network; and a wireless network module, serving as a wireless network client to connect the electronic apparatus to a wireless network. The network connection device operates in a router mode, an AP mode or a repeater mode, and automatically switches between different modes.

### BACKGROUND OF THE INVENTION

1. Field of the Invention

The disclosed embodiments of the present invention is related to a network connection device, and more particularly, to a network connection device which selectively connects to a wired network or a wireless network, and selectively makes a wireless network module operate in different modes to provide different functions.

2. Description of the Prior Art

A network connection method includes a wired network connection and a wireless network connection. Each of the two methods has advantages and disadvantages thereof. The wired network is more restricted to hardware and cables, but the network quality thereof is usually better. The wireless network is more convenient for user, but the network quality is unstable and is subject to interference.

In addition, the existing network connection device is usually utilized as a client. That is to say, connecting the electronic apparatus to a network relies on another network service provider (e.g., a base station). However, users may also desire a network connection device with other types of functions. For instance, if there are corners at home that have poor signal reception quality or there are many electronic apparatus needed to be connected to the network, a repeater may be employed to increase the coverage range of the network signal. Alternatively, the network connection device may be employed as a router to convert the wired network into the wireless network. Further, the network connection device may be employed as an Access Point (AP) to connect the electronic apparatuses to each other.

However, the existing network connection device normally provides only one of the network types/functions. Accordingly, users have to purchase a relatively large number of devices to meet the demands of the multiple network types or functions, which not only increases the cost, but also needs cumbersome steps to configure the devices to operate normally.

### SUMMARY OF THE INVENTION

Accordingly, one of the objectives of the present invention is to provide a network connection device which connects to a wired network or wireless network selectively, and provides different functions selectively.

A first embodiment of the present invention discloses a network connection device, including: a wired network module, arranged for connecting an electronic apparatus to a wired network; and a wireless network module, arranged as a wireless network client in a client mode, connecting the electronic apparatus to a wireless network.

A second embodiment of the present invention discloses a network connection device, including: a wired network module, arranged for connecting an electronic apparatus to a wired network; and a wireless network module; wherein the network connection device has at least two of the following four modes: a client mode, wherein the wireless network module connects the electronic apparatus to the wireless network; a router mode, wherein the wired network module connects to the wired network, and the wireless network module is arranged as a wireless network router; a base station mode, wherein the wireless network module is arranged as a wireless base station and receives at least one changing command to change the related parameter of the wireless network module and connects the electronic apparatus to other electronic apparatus directly through the wireless network module; and a repeater mode, wherein the network connection device connects to the wireless network which is arranged as a wireless network client and connects the electronic apparatus to a wireless network and is arranged as a wireless network base station simultaneously.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is diagram illustrating a connection between a network connection device and a notebook according an embodiment of the present invention.

FIG. 2 is a block diagram illustrating a network connection device operating in a router mode according to one embodiment of the present invention.

FIG. 3 is a block diagram illustrating a network connection device operating in a router mode according to another embodiment of the present invention.

FIG. 4 is a block diagram illustrating a network connection device operating in a client mode according to an embodiment of the present invention.

FIG. 5 is a block diagram illustrating a network connection device operating in a repeater mode according to an embodiment of the present invention.

FIG. 6 is a block diagram illustrating a network connection device operating in a base station mode according to an embodiment of the present invention.

FIG. 7 is diagram illustrating a state machine of a network connection device according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is electrically connected to another device, that connection may be through a direct electrical connection, or through an indirect electrical connection via other devices and connections.

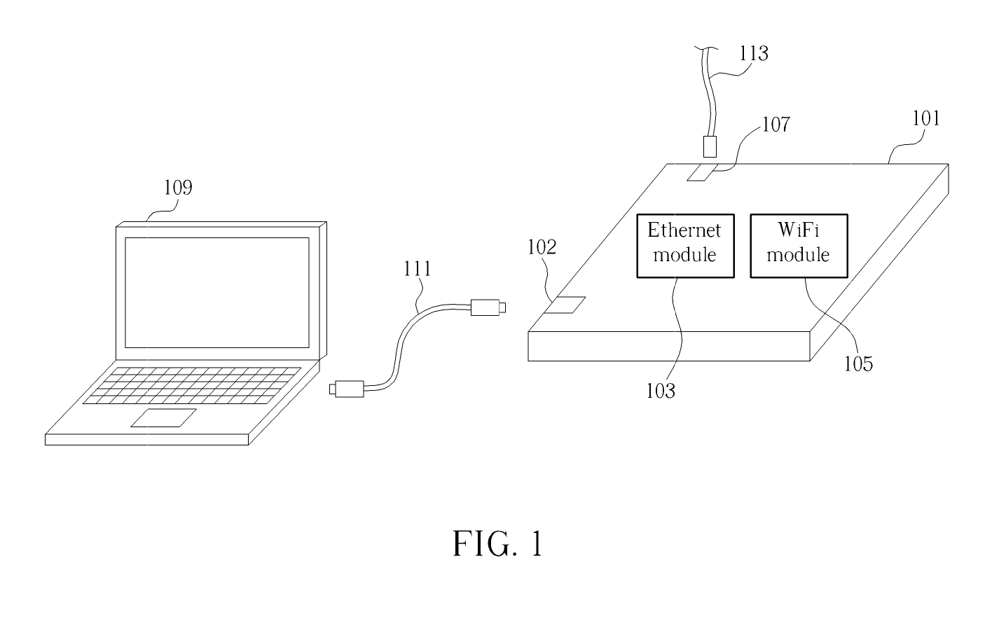

FIG. 1 is diagram illustrating a connection between a network connection device 101 and a notebook 109 according an embodiment of the present invention. As shown in FIG. 1, the network connection device 101 includes an Ethernet network module 103 and a WiFi module 105. In addition, the network connection device 101 also includes a Universal Serial Bus (USB) interface 102 and a network interface 107. The network connection device 101 may connect to the notebook 109 through the USB interface 102 and a USB cable 111. The Ethernet network module 103 may connect to other network equipments through a network cable 113 and thus connect to the Internet, thus making the notebook 109 connected to the Internet. Regarding the WiFi module 105, it may be utilized as a client, a repeater, a router, or a base station. It should be noted that the network connection device 101 in FIG. 1 is connected to the notebook 109 through the USB interface; however, any alternative connection means between the network connection device 101 and the notebook 109 are feasible. Besides, the network connection device 101 may be built in a notebook or other electronic apparatus. In addition, the Ethernet network module 103 may be a wired network module complying with other protocols. Similarly, the WiFi module 105 may be a wireless network module complying with other protocols.

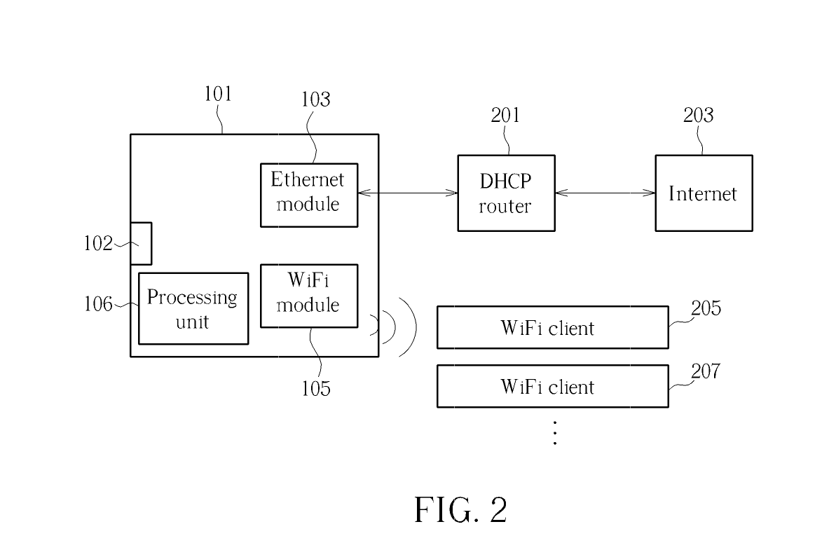

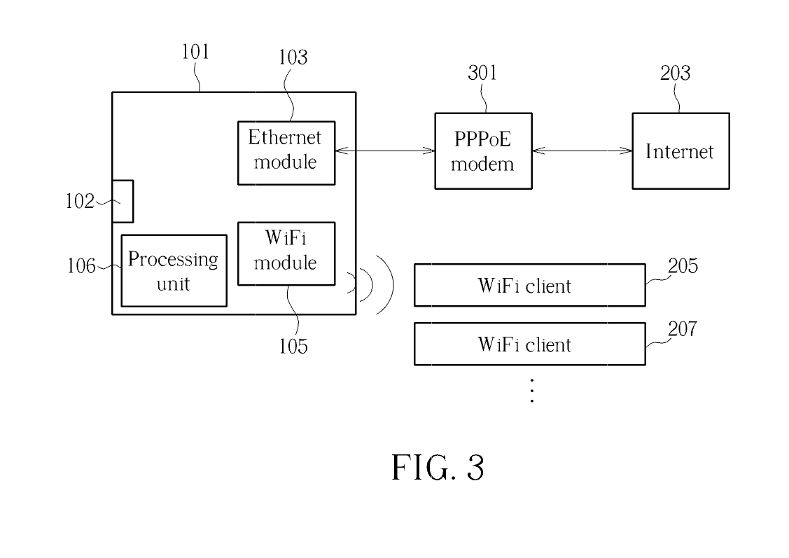

FIG. 2 and FIG. 3 are block diagrams illustrating a network connection device operating in a router mode according to embodiments of the present invention. In this router mode, the Ethernet module 103 is connected to Internet 203. A processing unit 106 of the network connection device 101 is capable of detecting the network environment and correspondingly configuring the Ethernet module 103, such that the Ethernet module 103 is connected to the Internet 203 under various network environments. For instance, the Ethernet module 103 may be connected to the Internet 203 through a DHCP (Dynamic Host Configuration Protocol) router as shown in FIG. 2, and may be connected to the Internet 203 through a PPPoE (Point-to-Point Protocol over Ethernet) modem as shown in FIG. 3. Once the Ethernet module 103 is connected to the Internet 203, the WiFi module 105 may be utilized as a WiFi router to share the Internet with WiFi clients 205 and 207. In this way the network connection device 101 not only shares the Internet with the electronic apparatus connected to the USB interface 102 through the USB interface 102, but also shares a wireless network with other electronic apparatus.

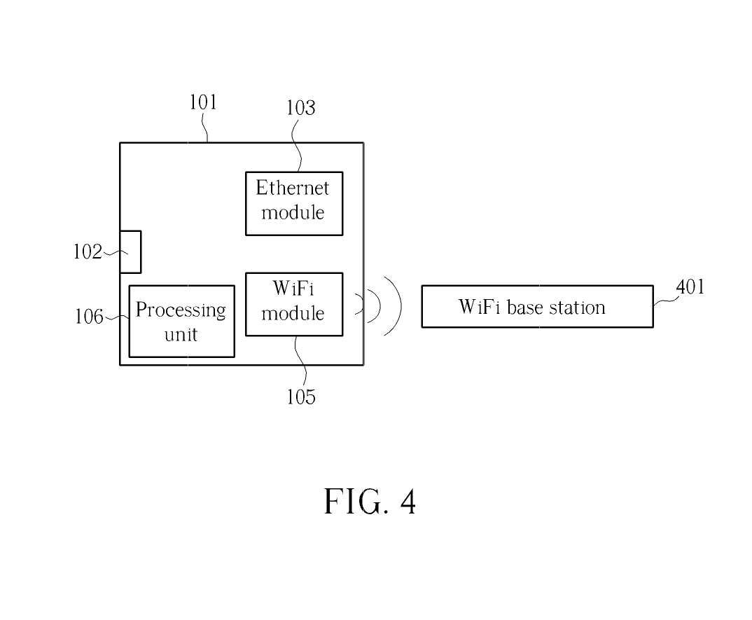

FIG. 4 is a block diagram illustrating the network connection device 101 operating in a client mode according to an embodiment of the present invention. As can be seen from FIG. 4, the WiFi module 105 is utilized as a client and connected to the network through a WiFi base station 401. In this case, the Ethernet module 103 may be disconnected from the Internet, or may be connected to the Internet but staying idle. In one embodiment, the processing unit 106 is capable of detecting whether the Ethernet module 103 is connected to the Internet during boot time, where the wired network is given higher priority to be connected if the Ethernet module 103 is able to connect to the Internet, otherwise the processing unit 106 will search the surroundings for a connectable wireless network base station available to the WiFi module 105 for allowing the WiFi module 105 to connect to the network through the wireless network base station.

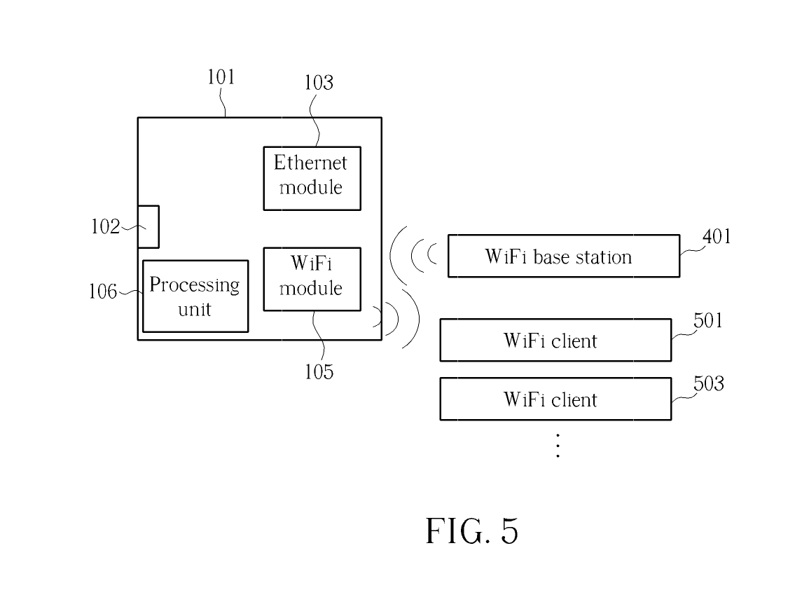

FIG. 5 is a block diagram illustrating the network connection device 101 operating in a repeater mode according to an embodiment of the present invention. In this mode, the WiFi module 105 is utilized as a client and connected to the wireless network through the WiFi base station 401. At the same time, the WiFi module 105 is also utilized as a wireless network base station to share the network with WiFi clients 501 and 503. The network connection device 101 searches for a USB signal, and enter this mode after ensuring that the network connection device 101 is connected to the USB power source.

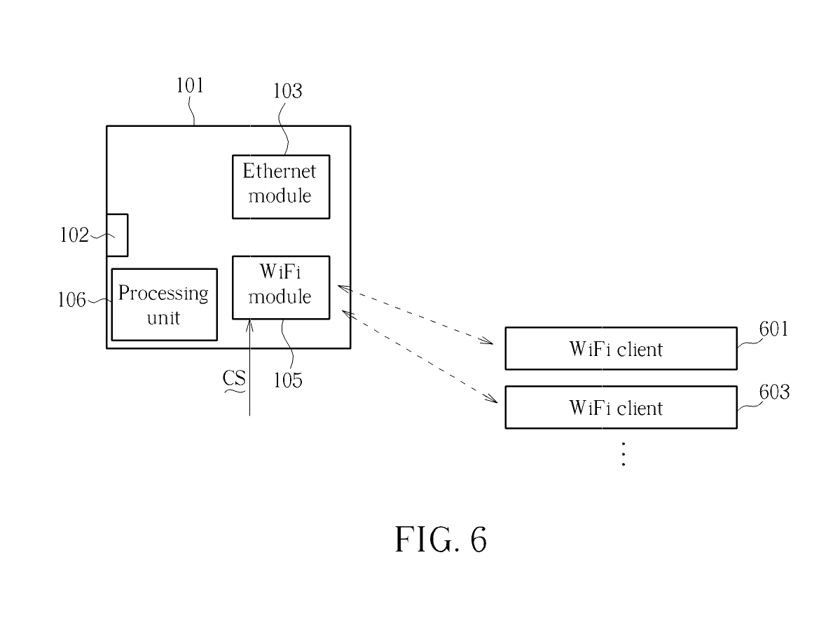

FIG. 6 is a block diagram illustrating the network connection device 101 operating in a base station mode according to an embodiment of the present invention. In this mode, the WiFi module 105 is utilized as a base station. The difference between the wireless base station 105 shown in FIG. 6 and the WiFi base station 105 shown in FIG. 4 is that the WiFi module 105 in FIG. 4 is capable of being connected to the wireless network after the connection is set up with the WiFi base station 401. However, the wireless base station shown in FIG. 6 could only connect the electronic apparatuses which are linked to the USB interface 102 to the other electronic apparatuses such as WiFi clients 601, 603, where none of the electronic apparatuses linked to the USB interface 102 and the WiFi clients 601, 603 is connected to the Internet or the wireless network. In this embodiment, the WiFi module 105 may receive a changing command CS to change the parameters of the WiFi module 105 serving as the wireless base station. Besides, in this mode, the Ethernet module 103 may be disconnected from the Internet, or may be connected to the Internet but staying idle.

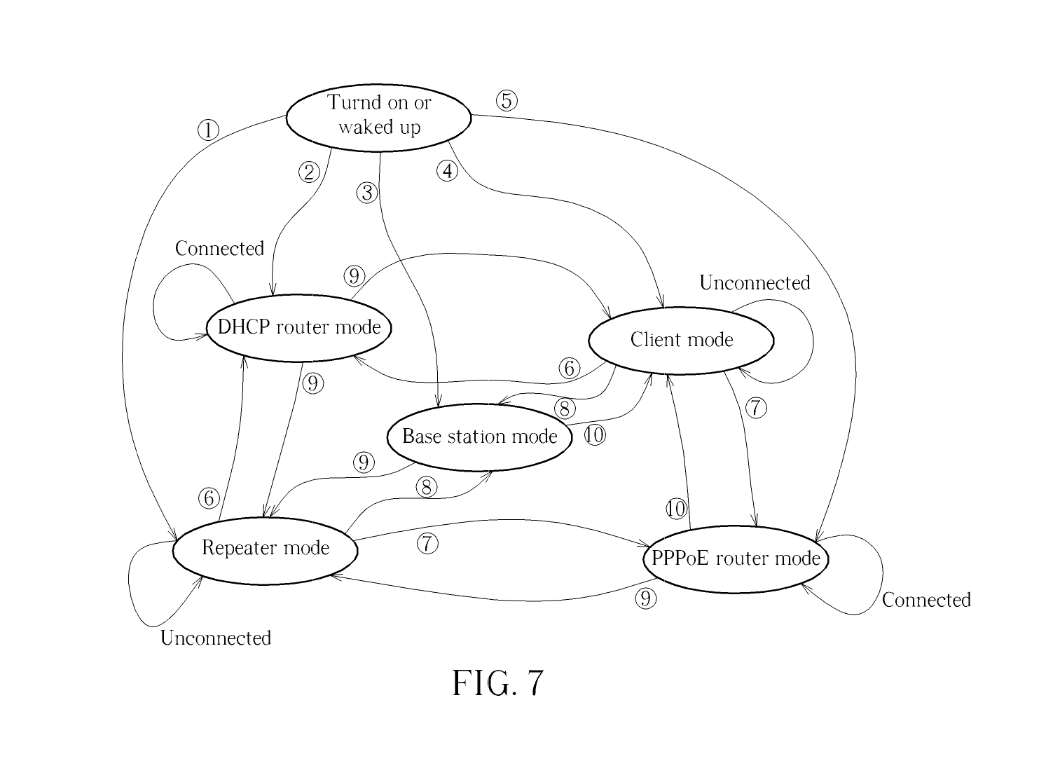

The exemplary network connection device of the present invention may have at least one of the aforementioned modes. Moreover, the user may choose a needed mode by himself/herself, or the network connection device may switch between different modes automatically according to the connection status between the Ethernet network module and the wired network or the connection status between the WiFi network module and the wireless network. FIG. 7 is diagram illustrating the state machine of the network connection device 101 according to an embodiment of the present invention. As shown in FIG. 7, after the network connection device is turned on or waked up, the network connection device will enter one of the five modes, including the DHCP router mode (FIG. 2), the PPPoE router mode (FIG. 3), the client mode (FIG. 4), the repeater mode (FIG. 5) and the base station mode (FIG. 6), based on which of the conditions 1-5 is satisfied. Moreover, the network connection device may switch between different modes automatically according to the conditions 6-10. The term “connected” in FIG. 7 and the related description thereof is representative of the Ethernet module being connected, and the term “unconnected” is representative of the Ethernet module being disconnected.

Further details of the conditions 1-10 are described as below:

Condition 1: Unconnected. Besides, the network connection device is connected to a USB power source (or any power source).

Condition 2: Connected. Besides, the network connection device finds the related information about the DHCP, and the Internet is connectable.

Condition 3: Connected. Besides, the network connection device finds the related information about the DHCP, but the Internet is not connectable; or the network connection device is connected to the Internet, but does not find the information about the DHCP and the PPPoE, that is to say, the wired network is unusable.

Condition 4: Unconnected. Besides, the network connection device is connected to a computer or a notebook.

Condition 5: Connected. Besides, the network connection device does not find the related information about the DHCP, but finds the information about the PPPoE.

Condition 6: Connected for more than 2 seconds. Besides, the network connection device finds the related information about the DHCP, and the Internet is connectable.

Condition 7: Connected for more than 2 seconds. Besides, the network connection device does not find the related information about the DHCP, but finds the information about the PPPoE.

Condition 8: Connected for more than 2 seconds. Besides, the network connection device finds the related information about the DHCP, but the Internet is not connectable, that is to say, the wired network is unusable.

Condition 9: Unconnected for mote than 2 seconds. Besides, the network connection device is electrically connected to a USB power source.

Condition 10: Unconnected for more than 2 seconds. Besides, the network connection device is electrically connected to a computer or a notebook.

According to the above descriptions of the modes, it should be readily known that the exemplary network connection device of the present invention is capable of switching between different modes automatically according to the connection status between the wired network module and the wired network, or the connection status between the wireless network module and the wireless network. Furthermore, the network connection device may switch between different modes automatically by further checking whether an electronic apparatus or a power source is connected thereto. Please note that the conditions about the mode switching in FIG. 7 are for illustrative purposes only. Those skilled in the art could make modifications to the conditions, and those alterations should fall within the scope of the present invention.

According to the above description of the embodiments, the exemplary network connection device connects to a wired network or wireless network selectively, and provides different functions selectively. Further, the exemplary network connection device switches between different modes automatically according to the parameters. In this way, the network connection device provides considerable convenience.

The descriptions hereinbefore are only the embodiments of the present invention, those modifications and alterations according to the present invention are all fall within the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A network connection device, comprising:
a wired network module, arranged for connecting an electronic apparatus to a wired network; and
a wireless network module, arranged for serving as a wireless network client in a client mode to connect the electronic apparatus to a wireless network.

2. The network connection device of claim 1, wherein the wired network module is an Ethernet module.

3. The network connection device of claim 1, wherein the wireless network module is a WiFi module.

4. The network connection device of claim 1, wherein the wireless network module is arranged for serving as a wireless network router when the network connection device connects to the wired network and the wireless network module operates in a router mode.

5. The network connection device of claim 1, wherein the wireless network module is arranged for serving as a wireless base station when operating in a wireless base station mode, and receiving at least one changing command to change a related parameter setting of the wireless network module serving as the wireless base station for connecting the electronic apparatus to other electronic apparatus directly through the wireless network module.

6. The network connection device of claim 1, wherein the wireless network module is arranged for serving as a wireless network client, connecting the electronic apparatus to a wireless network, and simultaneously serving as a wireless network base station when the wireless network module operates in a repeater mode.

7. A network connection device, comprising:
a wired network module, arranged for connecting an electronic apparatus to a wired network; and
a wireless network module;
wherein the network connection device has at least two of following four modes:
a client mode, in which the wireless network module connects the electronic apparatus to a wireless network;
a router mode, in which the wired network module connects to the wired network, and the wireless network module is arranged for serving as a wireless network router;
a base station mode, in which the wireless network module is arranged for serving as a wireless base station and receiving at least one changing command to change a related parameter setting of the wireless network module serving as the wireless base station for connecting the electronic apparatus to other electronic apparatus directly through the wireless network module; and
a repeater mode, in which the network connection device connects to the wireless network, where the wireless network module is arranged for serving as a wireless network client, connecting the electronic apparatus to the wireless network, and simultaneously serving as a wireless network base station.

8. The network connection device of claim 7, wherein the wired network module is an Ethernet module.

9. The network connection device of claim 7, wherein the wireless network module is a WiFi module.

10. The network connection device of claim 7, wherein the wired network is given priority to be connected if the network connection device is able to connect to the wired network through the wired network module.

11. The network connection device of claim 7, wherein the network connection device further switches between different modes automatically according to a connection status between the wired network module and the wired network, or a connection status between the wireless network module and the wireless network.

12. The network connection device of claim 11, wherein the network connection device further switches between different modes automatically by checking whether the electronic apparatus or a power source is connected thereto.
